(19) United States
(12) Patent Application Publication
(10) Pub. No.: US 2025/0016892 A1
(43) Pub. Date: Jan. 9, 2025

(54) TEMPERATURE CONTROL METHOD AND APPARATUS FOR MAGNETIC HEAT-EMITTING BODY, AND ELECTRONIC DEVICE

(71) Applicant: CHINA TOBACCO HUBEI INDUSTRIAL CORPORATION LIMITED, Wuhan, Hubei (CN)

(72) Inventors: Cong WU, Wuhan, Hubei (CN); Huachen LIU, Wuhan, Hubei (CN); Liangying TANG, Wuhan, Hubei (CN); Jian TAN, Wuhan, Hubei (CN); Ting HUANG, Wuhan, Hubei (CN)

(73) Assignee: CHINA TOBACCO HUBEI INDUSTRIAL CORPORATION LIMITED, Wuhan, Hubei (CN)

(21) Appl. No.: 18/712,726

(22) PCT Filed: Nov. 10, 2022
(86) PCT No.: PCT/CN2022/131052

§ 371 Date: May 23, 2024

(30) Foreign Application Priority Data
Dec. 2, 2021 (CN) 202111460311.2

(51) Int. Cl. H05B 6/06; A24F 40/465; A24F 40/53; A24F 40/57

(52) U.S. Cl. CPC H05B 6/06; A24F 40/465; A24F 40/53; A24F 40/57; H05B 2206/023

(57) ABSTRACT

A temperature control method and apparatus for a magnetic heat-emitting body, and an electronic device. The temperature control method comprises: acquiring parameter information of at least one heat-emitting body in a cigarette to be smoked; calculating a first intensity of a magnetic field that corresponds to a Curie temperature, and controlling a first intensity of current, which passes through a coil inside a smoking set, such that the intensity of a magnetic field that is generated by the coil is constant at the first intensity of the magnetic field; and receiving a temperature adjustment instruction, determining a required temperature corresponding to the temperature adjustment instruction, calculating a second intensity of current on the basis of the required temperature and a resistance temperature coefficient, and controlling the intensity of current, which passes through the heat-emitting body, to be the second intensity of current.

The present application claims priority to Chinese Patent Application No. 202111460311.2, titled “TEMPERATURE CONTROL METHOD AND APPARATUS FOR MAGNETIC HEAT-EMITTING BODY, AND ELECTRONIC DEVICE”, filed on Dec. 2, 2021 with the China National Intellectual Property Administration, which is incorporated herein by reference in its entirety.

### FIELD

The present disclosure relates to the technical field of temperature control for heating elements, and in particular to a temperature control method and a temperature control apparatus for a magnetic heating element, and an electronic device.

### BACKGROUND

During heating of a heat-not-burn vaping set, a cigarette inserted into the heat-not-burn vaping set is heated to generate aerosols. According to the conventional heating methods, a current-induction resistor material, such as a heating wire, is inserted into a cigarette and is energized by the vaping set, and TCR temperature control is performed on the current-induction resistor material for heating. Generally, aerosol generation matrix is heated to a temperature of several hundred degrees to effectively and stably generate aerosols, which requires a large current and may cause a part of the aerosol generation matrix inside the cigarette to be burnt due to overheat.

Currently, a heating element made of magnetic material is arranged inside the cigarette, and magnetic induction heating is performed on the heating element by heating a magnetic field coil arranged inside the heat-not-burn vaping set. However, since the magnetic material has a characteristic of Curie temperature, the magnetic material has a significant difference in temperature change rate before and after the Curie temperature, and heating elements made of different magnetic materials differ in Curie temperature, resulting in low regulation accuracy on a heating temperature of the cigarette through magnetic induction heating.

### SUMMARY

In order to solve the above problem, a temperature control method and a temperature control apparatus for a magnetic heating element, and an electronic device are provided according to embodiments of the present disclosure.

In a first aspect, a temperature control method for a magnetic heating element is provided according to an embodiment of the present disclosure, and the method includes:
obtaining parameter information of at least one heating element in a to-be-smoked cigarette, where the at least one heating element includes a current-induction resistor material, and the parameter information includes a Curie temperature of the heating element and a temperature coefficient of resistance of the current-induction resistor material;
calculating a first magnetic field intensity corresponding to the Curie temperature, and controlling an intensity of current flowing through a coil inside a vaping set to be a first current intensity to control a magnetic field intensity generated by the coil to be constant at the first magnetic field intensity; and
receiving a temperature regulation instruction, determining a required temperature corresponding to the temperature regulation instruction, calculating a second current intensity based on the required temperature and the temperature coefficient of resistance, and controlling an intensity of current flowing through the heating element to be the second current intensity.

Preferably, the calculating a first magnetic field intensity corresponding to the Curie temperature includes:
determining, in a case that at least two Curie temperatures exist, a Curie temperature with a lowest temperature as a first Curie temperature and calculating a first magnetic field intensity corresponding to the first Curie temperature; and
determining, in a case that only one Curie temperature exists, the Curie temperature as a first Curie temperature and calculating a first magnetic field intensity corresponding to the first Curie temperature.

Preferably, the calculating a second current intensity based on the required temperature and the temperature coefficient of resistance includes:
calculating a first temperature difference between the required temperature and the first Curie temperature; and
calculating the second current intensity based on the first temperature difference and the temperature coefficient of resistance.

Preferably, after controlling the intensity of current flowing through the coil inside the vaping set to be the first current intensity to control the magnetic field intensity generated by the coil to be constant at the first magnetic field intensity, the method further includes:
determining, in the case that at least two Curie temperatures exist, a second Curie temperature and calculating a second temperature difference between the second Curie temperature and the first Curie temperature, where the second Curie temperature is a Curie temperature other than the first Curie temperature; and
calculating a third current intensity based on a temperature coefficient of resistance corresponding to the second Curie temperature and the second temperature difference, and controlling an intensity of current flowing through a second heating element to be the third current intensity, where the heating element includes a first heating element and the second heating element, the first heating element corresponds to the first Curie temperature, and the second heating element corresponds to the second Curie temperature.

Preferably, the calculating the second current intensity based on the first temperature difference and the temperature coefficient of resistance includes:
calculating the second current intensity based on the first temperature difference and the temperature coefficient of resistance in a case that the heating element is the first heating element; and
determining an actual temperature difference based on the first temperature difference and the second temperature difference and then calculating the second current intensity based on the actual temperature difference and the temperature coefficient of resistance, in a case that the heating element is the second heating element.

Preferably, the receiving a temperature regulation instruction, and determining a required temperature corresponding to the temperature regulation instruction includes: receiving the temperature regulation instruction, determining required temperature corresponding to the temperature regulation instruction, and determining a target heating element corresponding to the required temperature.

In a second aspect, a temperature control apparatus for a magnetic heating element is provided according to an embodiment of the present disclosure, and the apparatus includes: an obtaining module, a calculating module, and a receiving module. The obtaining module is configured to obtain parameter information of at least one heating element in a to-be-smoked cigarette, where the at least one heating element includes a current-induction resistor material, and the parameter information includes a Curie temperature of the heating element and a temperature coefficient of resistance of the current-induction resistor material. The calculating module is configured to calculate a first magnetic field intensity corresponding to the Curie temperature, and control an intensity of current flowing through a coil inside a vaping set to be a first current intensity to control a magnetic field intensity generated by the coil to be constant at the first magnetic field intensity. The receiving module is configured to receive a temperature regulation instruction, determine a required temperature corresponding to the temperature regulation instruction, calculate a second current intensity based on the required temperature and the temperature coefficient of resistance, and control an intensity of current flowing through the heating element to be the second current intensity.

In a third aspect, an electronic device is provided according to an embodiment of the present disclosure, and the electronic device includes a memory, a processor and a computer program stored in the memory and executable by the processor. The processor, when executing the computer program, performs the steps in the method according to the first aspect or any possible implementation in the first aspect.

In a fourth aspect, a computer-readable storage medium is provided according to an embodiment of the present disclosure. The computer-readable storage medium stores a computer program. The computer program, when executed by a processor, causes the processor to perform the steps in the method according to the first aspect or any possible implementation in the first aspect.

The beneficial effects of the present disclosure are as follows. A current-induction resistor material is added to a heating element, the heating element is heated to a Curie temperature through a magnetic field generated by a coil, and temperature control is performed on the current-induction resistor material in the heating element through TCR, ensuring the accuracy of temperature control. In addition, since the temperature of the heating element has already reached the Curie temperature under the action of the magnetic field, the heating element is heated through TCR only from the Curie temperature, avoiding the problem of burnt local aerosol generation matrix caused by excessive current in the conventional TCR heating method.

### BRIEF DESCRIPTION OF THE DRAWINGS

In order to more clearly illustrate technical solutions in embodiments of the present disclosure, drawings to be used in the embodiments are briefly described hereinafter. It is apparent that the drawings described below show only the embodiments of the present disclosure, and other drawings may be obtained by those skilled in the art from the drawings without any creative work.

FIG. 1 is a flowchart of a temperature control method for a magnetic heating element according to an embodiment of the present disclosure;

FIG. 2 is a schematic diagram showing a correspondence between a resistance and a temperature of a ferrite according to an embodiment of the present disclosure;

FIG. 3 is a schematic structural diagram of a temperature control apparatus for a magnetic heating element according to an embodiment of the present disclosure; and

FIG. 4 is a schematic structural diagram of an electronic device according to an embodiment of the present disclosure.

### DETAILED DESCRIPTION OF THE EMBODIMENTS

Technical solutions of embodiments of the present disclosure are clearly and completely described hereinafter in conjunction with the drawings of the embodiments of the present disclosure.

In the introduction hereinafter, the terms “first”, “second” are merely for a purpose of description, and should not be understood as indicating or implying relative importance. The following introduction provides multiple embodiments according to the present disclosure, and different embodiments may be replaced or combined. Hence, the present disclosure may also be considered to include all possible combinations of the same and/or different embodiments described. Thus, if one embodiment contains features A, B and C, and another embodiment contains features B and D, then the present disclosure should also be considered to include all other possible combinations containing one or more of A, B, C and D, although this embodiment may not be clearly written in the following content.

The following description provides examples, and does not limit the scope, applicability or examples described in the claims. Changes may be made in the function and arrangement of described elements without departing from the scope of the present disclosure. Various examples may be omitted, substituted, or added with various procedures or components as appropriate. For example, the methods described may be performed in an order different from that described, and various steps may be added, omitted, or combined. Furthermore, features described with respect to some examples may be combined into other examples.

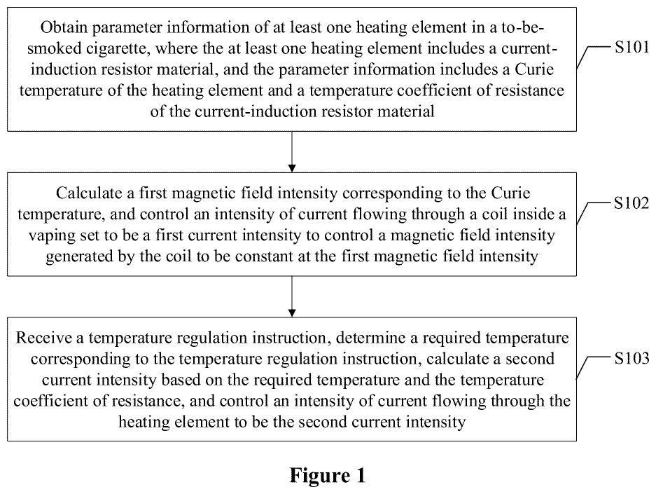

Reference is made to FIG. 1, which is a flowchart of a temperature control method for a magnetic heating element according to an embodiment of the present disclosure. In this embodiment of the present disclosure, the method includes the following steps S101 to S103.

In step S101, parameter information of at least one heating element in a to-be-smoked cigarette is obtained. The at least one heating element includes a current-induction resistor material, and the parameter information includes a Curie temperature of the heating element and a temperature coefficient of resistance of the current-induction resistor material.

The execution subject in the present disclosure may be a controller in a heat-not-burn vaping set.

In the embodiments of the present disclosure, the conventional heating element is generally made of a magnetic material such as alloys, and thus generates heat under the action of a coil magnetic field. In the present disclosure, during the production process of the heating element, in addition to the magnetic material, the heating element further includes the current-induction resistor material, such as manganese bronze. It should be noted that a material for manufacturing the conventional heating element is selected as a rigid body that can generate eddy current under the action of a magnetic field. The heating element has a characteristic of Curie temperature, that is, a temperature rapidly rises before the Curie temperature and is difficult to be controlled, the heating element is formed as a paramagnet after the Curie temperature and a temperature relatively smoothly rises and is easily to be controlled. Therefore, in order to match the temperature reached by the heating element with an actual heating requirement, the Curie temperature of the heating element is usually close to a conventional actual heating temperature of the vaping set, the heating element arranged in the cigarette is generally made of alloy, and the Curie temperature is regulated through a ratio of different materials in the alloy. A metal material in the current-induction resistor material may also serve as a material for manufacturing alloy, and thus it is completely feasible to add the current-induction resistor material to the heating element. As long as the final regulated Curie temperature is suitable, such manner does not affect an electromagnetic heating process of the heating element.

For example, as shown in FIG. 2, the heating element used in the present disclosure may be a ferrite with a negative temperature coefficient of resistance on a surface of a heating metal, so that the material has a zero temperature coefficient of resistance in a low temperature range, that is, the resistance does not vary with temperature. The ferrite has a Curie temperature ranging from 200° C. to 300° C. and has high-temperature protection and chemical protection on the heating metal. When a heating temperature reaches the Curie temperature of the ferrite, the ferrite decreases in magnetism and heating efficiency, causing an increase in inductor current. A calibration temperature is recognized through a signal of the increase in inductor current. As the temperature continues to rise, an increase in resistance of the metal dominates, and thus overall resistance increases. In addition, the temperature control and temperature recognition are achieved through TCR.

Specifically, after the to-be-smoked cigarette is inserted into the heat-not-burn vaping set, the controller may obtain the parameter information of the heating element in the to-be-smoked cigarette by recognizing a two-dimensional code on the to-be-smoked cigarette or other way, thereby determining the Curie temperature of the heating element and the temperature coefficient of resistance of the current-induction resistor material added to the heating element.

In step S102, a first magnetic field intensity corresponding to the Curie temperature is calculated, and an intensity of current flowing through a coil inside a vaping set is controlled to be a first current intensity to control a magnetic field intensity generated by the coil to be constant at the first magnetic field intensity.

In the embodiment of the present disclosure, due to the coil inside the vaping set having the constant number of turns and constant thickness, the magnetic field intensity generated by the coil may be determined based on the current flowing through the coil, thereby determining heat generated by a heating object in the magnetic field. This correspondence may be determined through experimental simulation and other manners during the design of the vaping set. Therefore, after the Curie temperature of the heating element is determined, and the Curie temperature serves as the temperature generated by the heating element for the normal heating operation of the vaping set, so that the first magnetic field intensity for heating the heating element to the Curie temperature may be calculated, so as to determine the first current intensity corresponding to the first magnetic field intensity. An intensity of current flowing through the coil is controlled to be the first current intensity, so that the magnetic field intensity generated by the coil is constant at the first magnetic field intensity, ensuring the temperature of the heating element remaining at the Curie temperature.

In an embodiment, the first magnetic field intensity corresponding to the Curie temperature is calculated by: determining, in a case that at least two Curie temperatures exist, a Curie temperature with a lowest temperature as a first Curie temperature, and calculating a first magnetic field intensity corresponding to the first Curie temperature; and determining, in a case that only one Curie temperature exists, the Curie temperature as a first Curie temperature and calculating a first magnetic field intensity corresponding to the first Curie temperature.

In the embodiment of the present disclosure, the to-be-smoked cigarette may include more than one heating element, different parts of the cigarette are to be heated at different temperatures, and thus various heating elements in the same cigarette differ in material composition, that is, the heating elements differ in Curie temperature. In this case, generation of heat only by the magnetic field may create a new problem, that is, as the magnetic field changes, various heating elements change in temperature and differ in change amplitude, further affecting the accuracy of temperature control through magnetic field intensity. The conventional technology provides a solution as follows. Magnetic field coils different in number and thickness are arranged at different positions of the vaping set, in order to modify the magnetic field intensity at different positions. In this way, it is required to manufacture magnetic field coils with different specifications accordingly, devices are costly, and the problem that the temperature is roughly regulated to a range by coil magnetic field heating cannot be solved. In addition, the devices have relatively narrow applicability, and the accuracy of temperature control cannot be guaranteed when the to-be-smoked cigarette changes.

Specifically, in the present disclosure, the temperature control does not rely on magnetic field intensity, the heating element is preliminarily heated only by using the magnetic field intensity, and then temperature control is performed through TCR. Various heating elements are not significantly different in Curie temperature. Therefore, in a case that two or more Curie temperatures exist, that is, two or more different heating elements are included, a Curie temperature with a lowest temperature among the two or more Curie temperatures is determined as the first Curie temperature, and the first magnetic field intensity corresponding to the first Curie temperature is for heating. When the heating element is heated to the first Curie temperature, temperature control may further be performed through TCR on other heating element that has not reached respective Curie temperature. In a case that only one Curie temperature exists, the Curie temperature is directly determined as the first Curie temperature for calculation.

In step S103, a temperature regulation instruction is received, a required temperature corresponding to the temperature regulation instruction is determined, a second current intensity is calculated based on the required temperature and the temperature coefficient of resistance, and an intensity of current flowing through the heating element is controlled to be the second current intensity.

In the embodiment of the present disclosure, the temperature regulation instruction may be understood as an instruction generated in response to a regulation operation by the user pressing a key or in other manners on the heating temperature inside the vaping set.

In the embodiment of the present disclosure, different users have different requirements for heating the cigarette. Some users want to have a higher heating temperature to speed up the generation of the aerosol and improve the vaping experience each time. The temperature regulation instruction is generated in response to the regulation operation of the user on the heating temperature of the vaping set. On receipt of the temperature regulation instruction, the controller determines the required temperature to be regulated by analyzing the temperature regulation instruction, calculates the second current intensity based on the required temperature and the temperature coefficient of resistance corresponding to the heating element, and controls an intensity of current flowing through the heating element to be the second current intensity, to control resistance of the current-induction resistor material, thus achieving the TCR temperature control regulation on the heating element by a change in the resistance. Through the coil magnetic field, the heating element can be roughly heated to a temperature range, and accurate temperature control cannot be achieved. Only the Curie temperature can be accurately determined. Therefore, in the present disclosure, the heating element is heated to Curie temperature through electromagnetic heating, and then TCR temperature control is performed on the heating element through temperature coefficient of resistance. As the temperature coefficient of resistance is determined, that is, the relationship between resistance and temperature is determined, so that accurate temperature control can be achieved in this way. In addition, the heating element is heated through TCR temperature control only from the Curie temperature, that is, a temperature range is to be regulated is small, and the required current is also small, avoiding the problem that the temperature is controlled to rise several hundred degrees only through TCR, affecting the local aerosol generation matrix caused by excessive current in the conventional heating method.

The heating element in the to-be-smoked cigarette may be arranged in a cross-sectional shape, so that the heating element abuts against and directly contacts with an inner wall of the vaping set, thereby directly contacting with circuits arranged on the inner wall of the vaping set, facilitating the energization of the heating element by the vaping set.

In an embodiment, the second current intensity is calculated based on the required temperature and the temperature coefficient of resistance by: calculating a first temperature difference between the required temperature and the first Curie temperature; and calculating the second current intensity based on the first temperature difference and the temperature coefficient of resistance.

In the embodiment of the present disclosure, the required temperature set by the user is an actual heating temperature required by the user. In the TCR heating mode, heating is only for a difference between the first Curie temperature and the required temperature. Therefore, the first temperature difference is first calculated before calculating the second current intensity, and then a resistance value to be changed is calculated by the first temperature difference and the temperature coefficient of resistance, so as to determine the second current intensity.

In an embodiment, after the intensity of the current flowing through the coil inside the vaping set is controlled to be the first current intensity to control the magnetic field intensity generated by the coil to be constant at the first magnetic field intensity, the method further includes: determining, in the case that at least two Curie temperatures exist, a second Curie temperature and calculating a second temperature difference between the second Curie temperature and the first Curie temperature, where the second Curie temperature is a Curie temperature other than the first Curie temperature; and calculating a third current intensity based on a temperature coefficient of resistance corresponding to the second Curie temperature and the second temperature difference, and controlling an intensity of current flowing through a second heating element to be the third current intensity. The heating element includes a first heating element and the second heating element. The first heating element corresponds to the first Curie temperature. The second heating element corresponds to the second Curie temperature.

In the embodiment of the present disclosure, for multiple heating elements, only a heating element with the lowest Curie temperature is heated to the Curie temperature in the above heating step, while remaining heating elements have not heated to the respective Curie temperatures. From the above description, it can be seen that during the design of the heating element, the Curie temperature is an operating temperature of the heating element expected by the designer, which is an expected heating temperature of the heating element when the cigarette is normally smoked. Therefore, the remaining heating elements are to be heated to respective Curie temperatures through TCR temperature control.

Specifically, in a case that two or more Curie temperatures exist, the first Curie temperature is excluded from the obtained Curie temperatures, to obtain second Curie temperatures. For each of the second Curie temperatures, a difference between the second Curie temperature and the first Curie temperature is calculated, that is, how much more temperature each of the heating elements to be heated to reach the second Curie temperature is determined. After determining all second temperature differences, the third current intensity is calculated based on the second temperature differences, and an intensity of current flowing through the second heating element is controlled to be the third current intensity, so that all the heating elements can reach respective Curie temperatures in an initial state without temperature regulation.

In an embodiment, the second current intensity is calculated based on the first temperature difference and the temperature coefficient of resistance by: calculating the second current intensity based on the first temperature difference and the temperature coefficient of resistance in a case that the heating element is the first heating element; and determining an actual temperature difference based on the first temperature difference and the second temperature difference and calculating the second current intensity based on the actual temperature difference and the temperature coefficient of resistance in a case that the heating element is the second heating element.

In the embodiment of the present disclosure, for the second heating element, current with the second current intensity is applied to the second heating element, in order to reach the Curie temperature corresponding to the second heating element. Therefore, when temperature control is performed on the second heating element, the actual temperature difference is determined based on the first temperature difference and the second temperature difference, and the second current intensity is calculated based on the actual temperature difference and the temperature coefficient of resistance to ensure the accuracy of temperature control. For the first heating element, since no additional current is applied to the first heating element, the second current intensity is directly calculated based on the first temperature difference.

In an embodiment, the temperature regulation instruction is received, and the required temperature corresponding to the temperature regulation instruction is determined by receiving the temperature regulation instruction, determining required temperatures corresponding to the temperature regulation instruction, and determining a target heating element corresponding to the required temperature.

In the embodiment of the present disclosure, for the cigarette including multiple heating elements, temperature control may be performed on each of the heating elements separately. Specifically, on receipt of the temperature regulation instruction, in addition to determining the required temperatures, the controller further determines the target heating element corresponding to each of the required temperatures from the temperature regulation instruction, thereby achieving temperature regulation for the multiple heating elements.

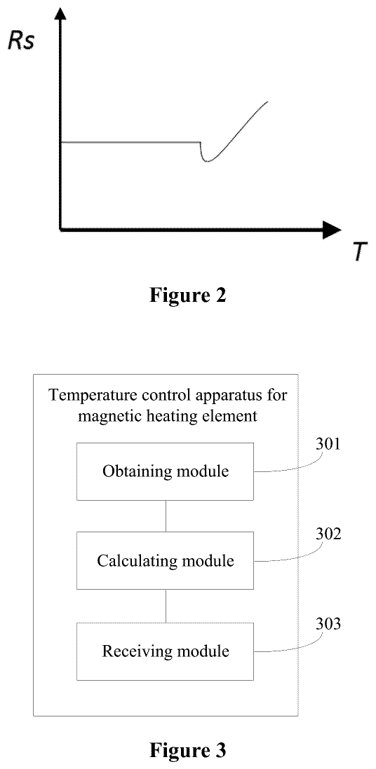

A temperature control apparatus for a magnetic heating element according to the embodiments of the present disclosure is described in detail below with reference to FIG. 3. It should be noted that the temperature control apparatus for a magnetic heating element shown in FIG. 3 is configured to perform the method according to the embodiment shown in FIG. 1 of the present disclosure, and for the sake of illustration, only the parts thereof relevant to the embodiment of the present disclosure are shown. For the specific technical details not disclosed, reference is made to the embodiment shown in FIG. 1 according to the present disclosure.

Reference is made to FIG. 3, which is a schematic structural diagram of a temperature control apparatus for a magnetic heating element according to an embodiment of the present disclosure. As shown in FIG. 3, the apparatus includes: an obtaining module 301, a calculating module 302 and a receiving module 303.

The obtaining module 301 is configured to obtain parameter information of at least one heating element in a to-be-smoked cigarette. The at least one heating element includes a current-induction resistor material. The parameter information includes a Curie temperature of the heating element and a temperature coefficient of resistance of the current-induction resistor material.

The calculating module 302 is configured to calculate a first magnetic field intensity corresponding to the Curie temperature, and control an intensity of current flowing through a coil inside a vaping set to be a first current intensity to control a magnetic field intensity generated by the coil to be constant at the first magnetic field intensity.

The receiving module 303 is configured to receive a temperature regulation instruction, determine a required temperature corresponding to the temperature regulation instruction, calculate a second current intensity based on the required temperature and the temperature coefficient of resistance, and control an intensity of current flowing through the heating element to be the second current intensity.

In an embodiment, the calculating module 302 includes a first temperature determining unit and a second temperature determining unit.

The first temperature determining unit is configured to determine, in a case that at least two Curie temperatures exist, a Curie temperature with a lowest temperature as a first Curie temperature and calculate a first magnetic field intensity corresponding to the first Curie temperature.

The second temperature determining unit is configured to determine, in a case that only one Curie temperature exists, the Curie temperature as a first Curie temperature and calculate a first magnetic field intensity corresponding to the first Curie temperature.

In an embodiment, the receiving module 303 includes a first calculating unit and a second calculating unit.

The first calculating unit is configured to calculate a first temperature difference between the required temperature and the first Curie temperature.

The second calculating unit is configured to calculate the second current intensity based on the first temperature difference and the temperature coefficient of resistance.

In an embodiment, the second temperature determining unit includes a first calculating element and a second calculating element.

The first calculating element is configured to determine, in the case that at least two Curie temperatures exist, a second Curie temperature and calculate a second temperature difference between the second Curie temperature and the first Curie temperature. The second Curie temperature is a Curie temperature other than the first Curie temperature

The second calculating element is configured to calculate a third current intensity based on the temperature coefficient of resistance corresponding to the second Curie temperature and the second temperature difference, and control an intensity of current flowing through a second heating element to be the third current intensity. The heating element includes a first heating element and the second heating element, the first heating element corresponds to the first Curie temperature, and the second heating element corresponds to the second Curie temperature.

In an embodiment, the receiving module 303 further includes a first processing unit and a second processing unit.

The first processing unit is configured to calculate the second current intensity based on the first temperature difference and the temperature coefficient of resistance in a case that the heating element is the first heating element

The second processing unit is configured to determine an actual temperature difference based on the first temperature difference and the second temperature difference and calculate the second current intensity based on the actual temperature difference and the temperature coefficient of resistance, in a case that the heating element is the second heating element.

In an embodiment, the receiving module 303 further includes a receiving unit.

The receiving unit is configured to receive the temperature regulation instruction, determine required temperature corresponding to the temperature regulation instruction, and determine a target heating element corresponding to the required temperature.

Those skilled in the art can clearly understand that the technical solutions of the embodiments of the present disclosure may be implemented by means of software and/or hardware. “Unit” and “module” in this specification refer to software and/or hardware that can independently complete or cooperate with other components to complete specific functions, where the hardware may be, for example, a field-programmable gate array (FPGA), or an integrated circuit (IC).

Each processing unit and/or module in the embodiment of the present disclosure may be implemented by an analog circuit for realizing the functions described in the embodiments of the present disclosure, or may be realized by software for performing the functions described in the embodiments of the present disclosure.

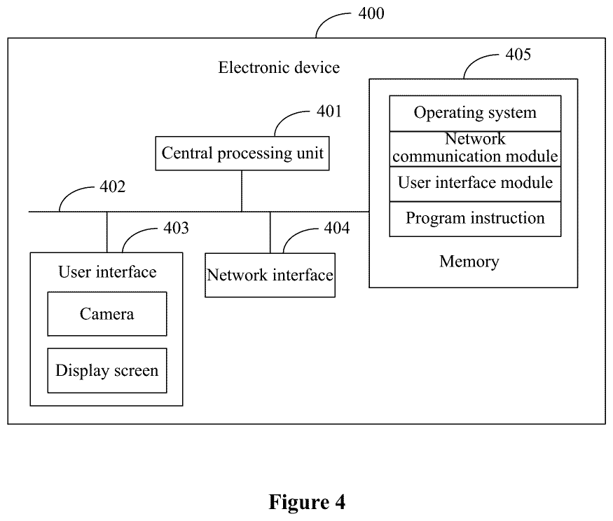

Reference is made to FIG. 4, which is a schematic structural diagram of an electronic device according to an embodiment of the present disclosure. The electronic device may be used to implement the method in the embodiment shown in FIG. 1. As shown in FIG. 4, the electronic device 400 may include: at least one central processing unit 401, at least one network interface 404, a user interface 403, a memory 405, and at least one communication bus 402.

The communication bus 402 is used to implement connection and communication between the modules.

The user interface 403 may include a display screen (Display) and a camera (Camera). In an embodiment, the user interface 403 may further include a standard wired interface and a wireless interface.

In an embodiment, the network interface 404 may include a standard wired interface and a wireless interface (such as a WI-FI interface).

The central processing unit 401 may include one or more processing cores. The central processing unit 401 connects various parts in the electronic device 400 by using various interfaces and lines, and executes various functions of the terminal 400 and processes data by running or executing instructions, programs, code sets or instruction sets stored in the memory 405 and calling data stored in the memory 405. In an embodiment, the central processing unit 401 may be implemented in at least one hardware manner selected from a digital signal processing (DSP), a field-programmable gate array (FPGA), and a programmable logic array (PLA). The central processing unit 401 may integrate one or a combination of a central processing unit (CPU), a graphics central processing unit (GPU), a modem, or the like. The CPU mainly handles the operating system, user interface, application programs, or the like; the GPU is used to render and draw the content to be displayed on the display screen; the modem is used to handle wireless communication. It can be understood that, the above modem may not be integrated into the central processing unit 401, and may be implemented by a single chip.

The memory 405 may include a random access memory (RAM), or may include a read-only memory. In an embodiment, the memory 405 includes a non-transitory computer-readable storage medium. The memory 405 may be used to store an instruction, a program, codes, a code set, or an instruction set. The memory 405 may include a program storage area and a data storage area, where the program storage area may store instructions for implementing an operating system, instructions for at least one function (such as a touch function, a sound playback function, or an image playback function), and instructions for implementing the embodiments of the method described above; the data storage area may store the data and the like involved in the embodiments of the method described above. In an embodiment, the memory 405 may be at least one storage device arranged away from the foregoing central processing unit 401. As shown in FIG. 4, the memory 405 as a computer storage medium may include an operating system, a network communication module, a user interface module, and a program instruction.

In the electronic device 400 shown in FIG. 4, the user interface 403 is mainly used to provide a user with an input interface to obtain data inputted by the user; and the central processing unit 401 may be used to invoke a temperature control application program for a magnetic heating element which is stored in the memory 405, to perform the following operations:
obtaining parameter information of at least one heating element in a to-be-smoked cigarette, where the at least one heating element includes a current-induction resistor material, and the parameter information includes a Curie temperature of the heating element and a temperature coefficient of resistance of the current-induction resistor material;
calculating a first magnetic field intensity corresponding to the Curie temperature, and controlling an intensity of current flowing through a coil inside a vaping set to be a first current intensity to control a magnetic field intensity generated by the coil to be constant at the first magnetic field intensity; and
receiving a temperature regulation instruction, determining a required temperature corresponding to the temperature regulation instruction, calculating a second current intensity based on the required temperature and the temperature coefficient of resistance, and controlling an intensity of current flowing through the heating element to be the second current intensity.

A computer-readable storage medium is further provided according to the present disclosure. The computer-readable storage medium stores a computer program, where the computer program, when executed by a processor, performs steps in the method described above. The computer-readable storage medium may include, but is not limited to, any type of disk, including a floppy disk, optical disk, DVD, CD-ROM, micro-driver, magneto-optical disk, ROM, RAM, EPROM, EEPROM, DRAM, VRAM, flash memory device, magnetic card or optical card, nano-system (including molecular memory IC), or any type of medium or device suitable for storing instructions and/or data.

It should be noted that for the foregoing embodiments of the method, for the sake of simple description, they are expressed as a series of action combinations, but those skilled in the art should know that the present disclosure is not limited by the described action sequence. Depending on the present disclosure, certain steps may be performed in other orders or simultaneously. Secondly, those skilled in the art should also know that the embodiments described in the specification are some preferred embodiments, and the actions and modules involved are not necessarily required by the present disclosure.

In the foregoing embodiments, the descriptions of each embodiment have their own emphases, and for parts not described in detail in one embodiment, reference may be made to relevant descriptions of other embodiments.

In the several embodiments provided in the present disclosure, it should be understood that the disclosed apparatus may be implemented in other ways. For example, the embodiments of the apparatus described above are only illustrative. For example, the division of the units is only a logical function division. In actual implementation, there may be other division manners. For example, multiple units or components may be combined or may be integrated into another system, or some features may be ignored, or not implemented. Additionally, the mutual coupling or direct coupling or communication connection shown or discussed may be through some service interfaces, and the indirect coupling or communication connection of apparatuses or units, and may be in electrical or other forms.

The units described as separate components may or may not be physically separated, and the components shown as units may or may not be physical units, that is, they may be located in one place, or may be distributed to multiple network units. Some or all of the units may be selected according to actual needs to achieve the purpose of the solution of the embodiments.

In addition, each functional unit in each embodiment of the present disclosure may be integrated into one processing unit, each unit may exist separately physically, or two or more units may be integrated into one unit. The integrated units described above may be implemented in the form of hardware or in the form of a software function unit.

If the integrated unit is realized in the form of a software function unit and sold or used as an independent product, the integrated unit can be stored in a computer-readable memory. Based on this understanding, the technical solutions of the embodiments of the present disclosure are essentially or a part that contributes to the conventional technology, or all or part of the technical solutions may be embodied in the form of a software product. The computer software product is stored in a memory and includes several instructions so that a computer device (such as a personal computer, a server, or a network device) executes all or part of the steps of the method described in the embodiments of the present disclosure. The foregoing memory includes: various media capable of storing program codes such as a U disk, a read-only memory (ROM), a random access memory (RAM), a mobile hard disk, a magnetic disk or an optical disk.

Those skilled in the art can understand that all or some of the steps in the various methods of the embodiments described above can be completed by a program instructing the related hardware. The program may be stored in a computer-readable memory, and the memory may include: a flash memory disk, a read-only memory (ROM), a random access memory (RAM), a magnetic disk, an optical disk, or the like.

The embodiments described above are merely some exemplary embodiments of the present disclosure, and should not limit the scope of the present disclosure. That is, all equivalent changes and modifications made according to the teachings of the present disclosure still fall within the scope of the present disclosure. Embodiments of the present disclosure will be readily apparent to those skilled in the art from consideration of the specification and practice of the disclosure herein. This application is intended to cover any variation, application or adapted modification of the present disclosure. These variation, application or adapted modification follow the general principles of the present disclosure and include common knowledge or conventional technical means in the technical field not described in the present disclosure. The specification and embodiments are to be considered exemplary only, and the scope and spirit of the present disclosure are defined by the claims.

1. A temperature control method for a magnetic heating element, comprising:
obtaining parameter information of at least one heating element in a to-be-smoked cigarette, wherein the at least one heating element comprises a current-induction resistor material, and the parameter information comprises a Curie temperature of the heating element and a temperature coefficient of resistance of the current-induction resistor material;
calculating a first magnetic field intensity corresponding to the Curie temperature, and controlling an intensity of current flowing through a coil inside a vaping set to be a first current intensity to control a magnetic field intensity generated by the coil to be constant at the first magnetic field intensity; and
receiving a temperature regulation instruction, determining a required temperature corresponding to the temperature regulation instruction, calculating a second current intensity based on the required temperature and the temperature coefficient of resistance, and controlling an intensity of current flowing through the heating element to be the second current intensity.

2. The method according to claim 1, wherein the calculating a first magnetic field intensity corresponding to the Curie temperature comprises:
determining, in a case that at least two Curie temperatures exist, a Curie temperature with a lowest temperature as a first Curie temperature and calculating a first magnetic field intensity corresponding to the first Curie temperature; and
determining, in a case that only one Curie temperature exists, the Curie temperature as a first Curie temperature and calculating a first magnetic field intensity corresponding to the first Curie temperature.

3. The method according to claim 2, wherein the calculating a second current intensity based on the required temperature and the temperature coefficient of resistance comprises:
calculating a first temperature difference between the required temperature and the first Curie temperature; and
calculating the second current intensity based on the first temperature difference and the temperature coefficient of resistance.

4. The method according to claim 3, wherein after controlling the intensity of current flowing through the coil inside the vaping set to be the first current intensity to control the magnetic field intensity generated by the coil to be constant at the first magnetic field intensity, the method further comprises:
determining, in the case that at least two Curie temperatures exist, a second Curie temperature and calculating a second temperature difference between the second Curie temperature and the first Curie temperature, wherein the second Curie temperature is a Curie temperature other than the first Curie temperature; and
calculating a third current intensity based on a temperature coefficient of resistance corresponding to the second Curie temperature and the second temperature difference, and controlling an intensity of current flowing through a second heating element to be the third current intensity, wherein the heating element comprises a first heating element and the second heating element, the first heating element corresponds to the first Curie temperature, and the second heating element corresponds to the second Curie temperature.

5. The method according to claim 4, wherein the calculating the second current intensity based on the first temperature difference and the temperature coefficient of resistance comprises:
calculating, in a case that the heating element is the first heating element, the second current intensity based on the first temperature difference and the temperature coefficient of resistance; and
determining, in a case that the heating element is the second heating element, an actual temperature difference based on the first temperature difference and the second temperature difference and then calculating the second current intensity based on the actual temperature difference and the temperature coefficient of resistance.

6. The method according to claim 1, wherein the receiving a temperature regulation instruction and determining a required temperature corresponding to the temperature regulation instruction comprises:
receiving the temperature regulation instruction, determining the required temperature corresponding to the temperature regulation instruction, and determining a target heating element corresponding to the required temperature.

7. A temperature control apparatus for a magnetic heating element, comprising:
an obtaining module, configured to obtain parameter information of at least one heating element in a to-be-smoked cigarette, wherein the at least one heating element comprises a current-induction resistor material, and the parameter information comprises a Curie temperature of the heating element and a temperature coefficient of resistance of the current-induction resistor material;
a calculating module, configured to calculate a first magnetic field intensity corresponding to the Curie temperature, and control an intensity of current flowing through a coil inside a vaping set to be a first current intensity to control a magnetic field intensity generated by the coil to be constant at the first magnetic field intensity; and
a receiving module, configured to receive a temperature regulation instruction, determine a required temperature corresponding to the temperature regulation instruction, calculate a second current intensity based on the required temperature and the temperature coefficient of resistance, and control an intensity of current flowing through the heating element to be the second current intensity.

8. An electronic device, comprising:
a memory;
a processor; and
a computer program stored in the memory and executed in the processor;
wherein the processor, when executing the computer program, performs the method according to claim 1.

9. A computer-readable storage medium, storing a computer program, wherein the computer program, when executed by a processor, causes the processor to perform the method according to claim 1.
